(19) United States
(12) Patent Application Publication
(10) Pub. No.: US 2014/0210346 A1
(43) Pub. Date: Jul. 31, 2014

(54) LIGHT EMITTING DIODE LAMP AND SYSTEM OF THE SAME

(71) Applicant: CHUN-HUNG CHEN, TAICHUNG CITY (TW)

(72) Inventor: CHUN-HUNG CHEN, TAICHUNG CITY (TW)

(21) Appl. No.: 13/754,839

(22) Filed: Jan. 30, 2013

(51) Int. Cl. F21V 23/00

(52) U.S. Cl. CPC F21V 23/005
USPC 315/113; 315/294

(57) ABSTRACT

A light emitting diode lamp system, comprising: multiple lamps, a control module, multiple hubs and a receiver. Each of the multiple lamps includes a main body and a heat sink. The control module includes a second circuit board and multiple input units. The multiple input units include a dynamic light adjustment start key and a dynamic light adjustment stop key. Each of the multiple hubs is coupled with multiple lamps and power supply units. The receiver is coupled with multiple hubs and receives the first-light-source control signal. Therefore, through the unique design of the main body, the present disclosure can be applied on a traditional lamp, or applied with an MR16 lamp fixture, thereby the present disclosure can increase the range of application of the light emitting diode lamp and the system of the same.

### BACKGROUND OF THE INVENTION

1. Field of the Invention

The present disclosure relates to a light emitting diode lamp and a system of the same; in particular, to a lamp applicable on an MR16 lamp fixture and a system of the same.

2. Description of Related Art

Light emitting diode is widely used in advertisement lights, running display boards, decoration, car lights, and cell phones. These lights are not systematically integrated, and are unable to promptly adjust the brightness, color and warmth of the light. The method of control likewise is limited to controlling an on and off state. Therefore, traditional connection methods can no longer meet demands. A device which uses wireless transmission as a method for integrating various kinds of lamps is required.

However, in a typical lighting environment, light emitting diode lamps are used only in ordinary lighting environment. In order to be used in special events such as art museums, weddings, concerts, etc, the brightness and color of the lamps must be changed according to the occasion. However, given that the lamp holders of these light emitting diode lamps vary in form, the cost of changing the lamps is increased. Therefore, an improved design on hardware device that broadens the applicability of light emitting diode lamps is an important object for people in the industry.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present invention is to provide a light emitting diode lamp and a system of the same, which uses a main body together with an MR16 lamp fixture through an improved design of the hardware device of the light emitting diode lamp. In other words, the main body can be used independently or in conjunction with an MR16 lamp fixture, thereby broadening the applicability of the light emitting diode lamp of the present disclosure.

The present disclosure provides a light emitting diode lamp, including: a main body, and a heat sink. The main body has a light emitting module disposed therein. The light emitting module includes a first circuit board, at least one light emitting element and a dynamic light adjustment module. The light emitting element and the dynamic light adjustment module are disposed on the first circuit board. The dynamic light adjustment module has multiple light adjustment elements corresponding to the light emitting elements. The heat sink includes a heat sink base and multiple heat sink fins. One side of the heat sink base is connected to the main body. The other side of the heat sink base is connected to the multiple heat sink fins.

The present disclosure further provides a light emitting diode lamp system, including: a lamp and a control module. The lamp includes: a main body, with a light emitting module disposed therein. The light emitting module includes a first circuit board, at least one light emitting element, a dynamic light adjustment module and a receiver. The light emitting element, dynamic light adjustment module and receiver are disposed on the first circuit board. The dynamic light adjustment module has multiple light adjustment elements respectively corresponding to the light emitting elements. A heat sink includes a heat sink base and multiple heat sink fins. One side of the heat sink base is connected to the main body. The other side of the heat sink base is connected to the multiple heat sink fins. A reflecting unit is disposed at and connected to the bottom of the main body. A control module includes a second circuit board and multiple input units. The multiple input units include at least a dynamic light adjustment start key and a dynamic light adjustment stop key.

The present disclosure further provides a light emitting diode lamp system, including: at least one lamp, a control module, at least one hub and a receiver. The at least one lamp includes: a main body, with a light emitting module disposed therein. The light emitting module includes a first circuit board, at least one light emitting element, and a dynamic light adjustment module. The light emitting element and the dynamic light adjustment module are disposed on the first circuit board. The dynamic light adjustment module has multiple light adjustment elements respectively corresponding to the light emitting elements. The heat sink includes a heat sink base and multiple heat sink fins. One side of the heat sink base is connected to the main body. The other side of the heat sink base is connected to multiple heat sink fins. A control module includes a second circuit board and multiple input units. The multiple input units include at least a dynamic light adjustment start key and a dynamic light adjustment stop key. At least one hub is included. Each of the hubs is respectively coupled to multiple lamps and power supply units. A receiver is coupled with the hub and receives first-light-source control signals.

The advantage of the present disclosures lies in that a light emitting diode lamp and a system of the same provided by the present disclosure can broaden the applicability of the light emitting diode lamp system by a design of an “MR16 type reflecting unit.”

In order to further the understanding regarding the present invention, the following embodiments are provided along with illustrations to facilitate the disclosure of the present invention without limiting the same.

### BRIEF DESCRIPTION OF THE DRAWINGS

FIG. 1 shows a schematic diagram of a light emitting diode lamp of the present disclosure;

FIG. 2 shows a top view of light emitting elements and a dynamic light adjustment module of the present disclosure;

FIG. 3 shows a block diagram of a second embodiment of the present disclosure;

FIG. 4 shows a flowchart block diagram of a third embodiment of the present disclosure;

FIG. 5 shows a flowchart block diagram of a fourth embodiment of the present disclosure; and

FIG. 6 shows a control method for a light emitting diode lamp system of a fifth embodiment of the present disclosure.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### First Embodiment

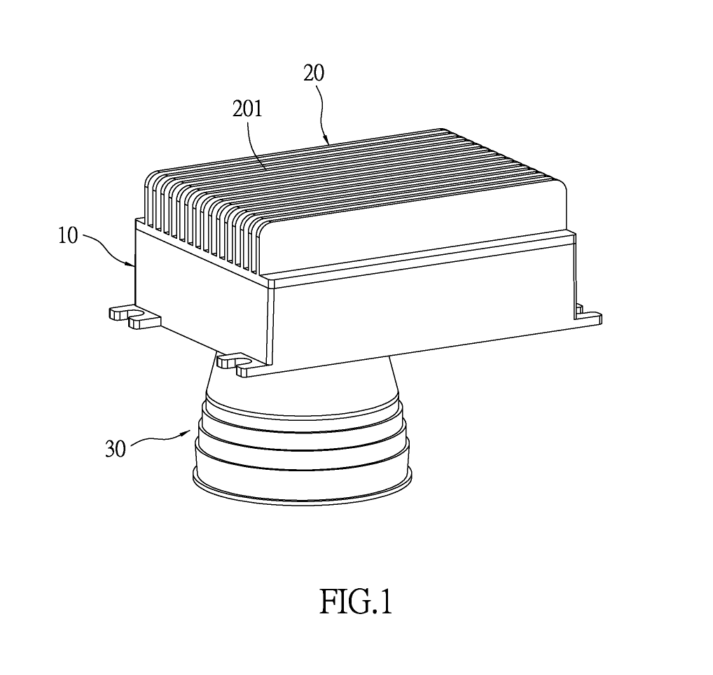

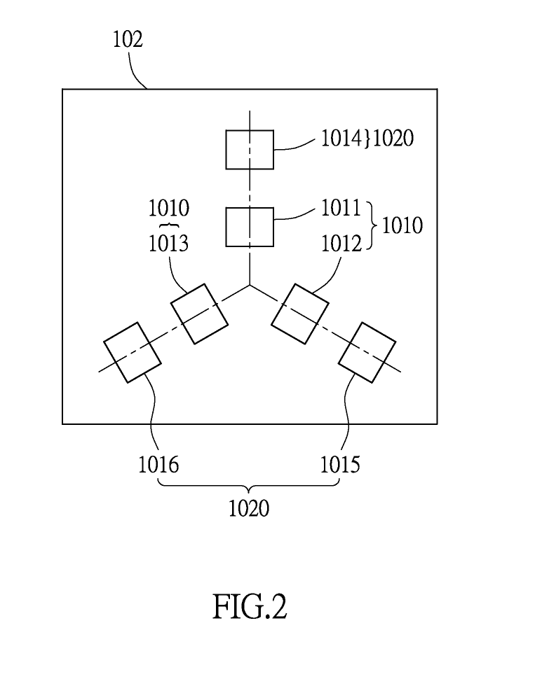

Referring to FIG. 1 and FIG. 2, the present disclosure provides a light emitting diode lamp, including: a main body 10 and a heat sink 20.

First, the main body 10 includes a light emitting module 101 disposed therein. The light emitting module 101 includes a first circuit board 102, at least one light emitting element 1020 and a dynamic light adjustment module 1010. Each of the light emitting element 1020 and the dynamic light adjustment module 1010 are disposed on the first circuit board 102. The dynamic light adjustment module 1010 has multiple light adjustment elements respectively corresponding to the light emitting elements 1020. The surface on the main body 10 opposite to the heat sink 20 has a circular groove serving as a light exit portion. The main body 10 can be made of metal or metal alloys, such as aluminum or aluminum alloys. The bottom of the circular groove of the main body 10 has a light scattering structure mainly for improving the light scattering ability of the light source. The light scattering structure can refract light from the light emitting element 1020 outwards, focusing them on a specific direction. However the present disclosure is not limited hereto.

The light emitting module 101 is made of multiple chips. The multiple chips are at least one light emitting element 1020 and a dynamic light adjustment module 1010. The multiple chips are arranged in array. The light emitting module 101 is electrically connected to the first circuit board 102. The light emitting element 1020 is mainly used for lighting and can include at least one white light emitting diode chip. The main function of the dynamic light adjustment module 1010 is to adjust the color of the light source. The light adjustment elements are respectively at least one blue light emitting diode chip 1011, at least one red light emitting diode chip 1012, and at least one green light emitting diode chip 1013.

In the present embodiment, the light emitting module 101 is formed by multiple chips. The multiple chips are three light emitting elements 1020 and a dynamic light adjustment module 1010. The three light emitting elements 1020 are arranged in array and respectively enclose the dynamic light adjustment module 1010. The light emitting module 101 is electrically connected to the first circuit board 102. The light emitting elements 1020 are mainly used for lighting. The three light emitting elements 1020 can include a first white light emitting diode chip 1014, a second white light emitting diode chip 1015, and a third white light emitting diode chip 1016. The main function of the dynamic light adjustment module 1010 is to adjust the color of the light source. The dynamic light adjustment module 1010 has light adjustment elements respectively corresponding to the light emitting elements 1020. The light adjustment elements are respectively a blue light emitting diode chip 1011, a red light emitting diode chip 1012, and a green light emitting diode chip 1013. However the present disclosure is not limited hereto.

Next, the heat sink 20 includes a heat sink base and multiple heat sink fins 201. One side of the heat sink base is connected to the main body 10. The other side of the heat sink base is connected to the multiple heat sink fins 201. By this configuration, the heat sink fins 201 provide a heat dissipating function for the main body 10. For example, the multiple heat sink fins 201 can be made of metal and capable of meeting the heat dissipation requirement of light emitting diodes operating for long periods of time. According to need, the user can dispose the light exit portion of the main body 10 on a lamp holder, decoration, or other objects with a groove, rendering the present disclosure with a wider range of application. However, the present disclosure is not limited hereto.

The present disclosure further includes a reflecting unit 30 disposed on the main body 10. The main body 10 has at least one magnetic unit within embedded on the inner surface of the circular groove. In other words, at least one magnetic permeable unit corresponding to the magnetic unit is disposed on the cone shaped surface of the reflecting unit 30, mainly for magnetically connecting to the magnetic unit. For example, when the user disassembles the reflecting unit 30 from the main body 10, he can easily disassemble or install through the magnetic attraction between the magnetic permeable unit and the magnetic unit. Additionally, the magnetic unit can be a magnet, and the magnetic permeable unit can be a screw, screw cap, or other unit made from magnetically permeable material not limited herein.

The outer surface of the reflecting unit 30 exhibits a round cone shape, whose diameter gradually decreases in the direction of the main body 10. Moreover, the reflecting unit 30 has a scattering structure and a partition (not shown in the figure). The main object of the scattering structure is to improve the scattering ability of the light source. The light scattering structure can refract light from the light emitting element 1020 outwards, focusing them on a specific direction. Therefore, when the user installs the present disclosure on top of a lamp holder with lighting, this configuration further increases the luminosity of the lighting.

Moreover, the partition is embedded at the top of the reflecting unit 30. Namely, the partition and the reflecting unit 30 are fitted together. The partition can be used to prevent external humidity, vapor, contaminants and foreign matters in the environment from entering the main body 10. By this configuration, the present disclosure can use this design to make the interior of the main body 10 and the reflecting unit 30 airtight, further increasing the water proof and contaminant proof abilities of the light emitting diode lamp.

Furthermore, through the design of the reflecting unit 30, the present disclosure can be applied on a traditional MR16 lamp fixture. Namely, the user can use the reflecting unit 30 independently and in conjunction with the MR16 lamp. By this configuration, the present disclosure can increase the applicability of the lamp system.

### Second Embodiment

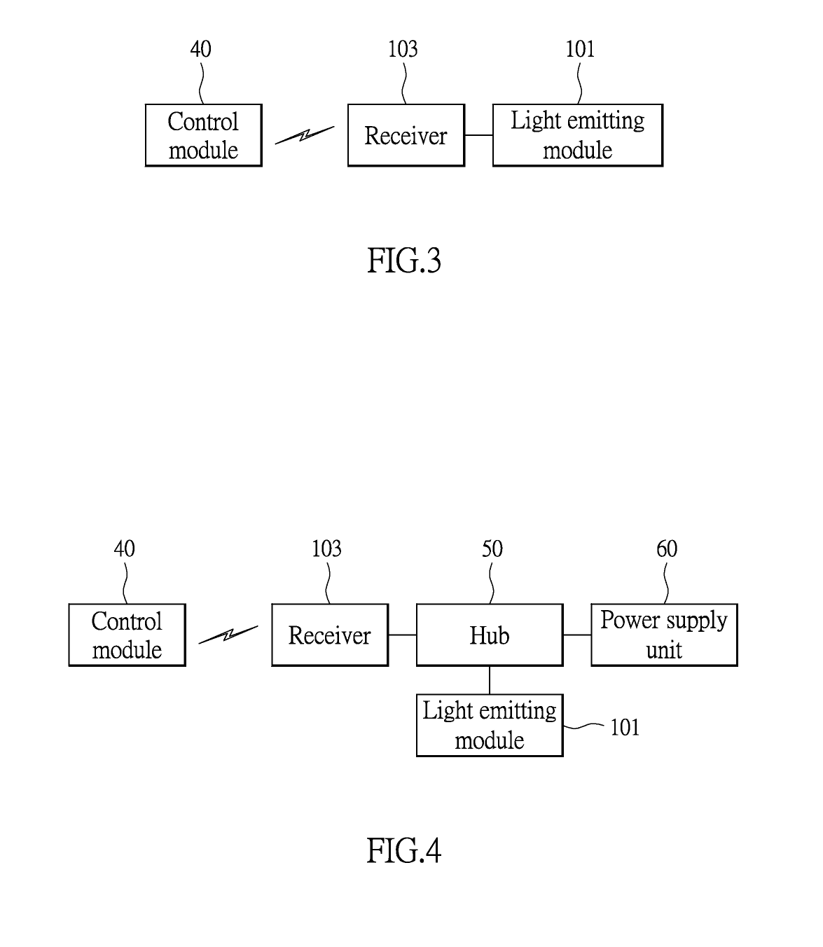

Referring to FIG. 2 to FIG. 3, the second embodiment of the present disclosure provides a light emitting diode lamp system, including: a lamp and a control module 40.

Its difference with the first embodiment lies in the light emitting diode lamp system, which in this case, further includes a control module 40 and a receiver 103, for extending the application range of the light emitting diode lamp system. The heat sink 20 of the second embodiment of the present disclosure is the same as the heat sink described in the first embodiment, and therefore is not further described.

First, the main body 10 has a light emitting module 101 disposed in the main body 10. The light emitting module 101 includes a first circuit board 102, at least one light emitting element 1020, a dynamic light adjustment module 1010 and a receiver 103. The first circuit board 102, the at least one light emitting element 1020, and the dynamic light adjustment module 1010 share much similarity with their respective counterparts in the previous embedment, and therefore will not be reiterated further. The surface on the main body 10 opposite to the heat sink 20 has a circular groove serving as a light exit portion. The main body 10 can be made of metal or metal alloys, such as aluminum or aluminum alloys. The bottom of the circular groove of the main body 10 has a light scattering structure mainly for improving the light scattering ability of the light source. The light scattering structure can refract light from the light emitting element 1020 outwards, focusing them on a specific direction. However the present disclosure is not limited hereto.

Moreover, the control module 40 is disposed outside the main body 10 and is coupled to a power supply unit 60. The control module 40 includes a second circuit board and multiple input units. The multiple input units include at least a dynamic light adjustment start key and a dynamic light adjustment stop key. When the user presses an input unit, a first-light-source control signal is produced and transmitted to the light emitting module 101.

Then, the multiple input units can be multiple keys for pressing by external forces. Other than on/off keys, the input units can also include a dynamic light adjustment start key, a dynamic light adjustment stop key, brightness adjustment key and various types of preset scenario mode keys. Additionally, the control module 40 can further have a saving unit, for saving modes set by the users in a self-set mode.

Additionally, the control module 40 can include a case. The upper surface of the case has input unit for external forces to press on. An accommodating space is formed within the case. The first circuit board 102 is disposed inside the accommodating space, such as a remote control device. When the user presses the input unit, the control module 40 produces a first-light-source control signal, which can be transmitted wirelessly by infrared, radio or Bluetooth to a light emitting module 101. However, the present disclosure is not limited hereto.

For example, when the user uses the light emitting module in lighting applications, the light emitting element 1020 drives at least a white light emitting diode chip according to the need of the user regarding brightness. When the user intends to adjust the light source emitted from the white light emitting diode, for example: warm colors, cool colors, at this moment, the color scheme can be adjusted by driving the light adjustment elements with the control module. When the user uses the light emitting module in non-lighting applications, at least one of the light adjustment element can be driven by the control module according to the need of the user regarding the light source color, thereby creating different light source colors.

Additionally, the light emitting module 101 further includes a receiver 103 for receiving the first-light-source control signals. When the light emitting module 101 receives the first-light-source control signal, differently colored light sources can be continuously created by controlling the blue light emitting diode chip 1011, the red light emitting diode chip 1012, the green light emitting diode chip 1013, and the synchronous or asynchronous light emission of the light adjustment elements. Additionally, the receiver 103 can be an infrared, radio or Bluetooth wireless receiver. For example in the present embodiment, the receiver 103 is an infrared receiver. However, the present disclosure is not limited hereto.

Finally, the lamp of the present disclosure can further include a reflecting unit 30 same as the description in the first embodiment, therefore the reflecting unit 30 is not further described.

### Third Embodiment

Referring to FIG. 4, the third embodiment of the present disclosure provides a light emitting diode lamp system, including: at least a lamp, a control module 40, a hub 50 and a receiver 103. A light emitting diode lamp system is formed by serial connection of a hub 50 with at least one lamp.

Its difference with the first embodiment lies in the light emitting diode lamp system, which in this case, further includes a control module 40, a hub 50 and a receiver 103, for extending the application range of the light emitting diode lamp system. The lamp of the third embodiment of the present disclosure is the same as the lamp described in the first embodiment, and therefore is not further described.

Moreover, the control module 40 is disposed outside the main body 10 and is coupled to a power supply unit 60. The control module 40 includes a second circuit board and multiple input units. The multiple input units include at least a dynamic light adjustment start key and a dynamic light adjustment stop key. When the user presses an input unit, a first-light-source control signal is produced and transmitted to the light emitting module 101.

Then, the multiple input units can be multiple keys for pressing by external forces. Other than on/off keys, the input units can also include a dynamic light adjustment start key, a dynamic light adjustment stop key, brightness adjustment key and various types of preset scenario mode keys. Additionally, the control module 40 can further have a saving unit, for saving modes set by the users in a self-set mode.

Additionally, the control module 40 can include a case. The upper surface of the case has input unit for external forces to press on. An accommodating space is formed within the case. The first circuit board 102 is disposed inside the accommodating space, such as a remote control device. When the user presses the input unit, the control module 40 produces a first-light-source control signal, which can be transmitted wirelessly by infrared, radio or Bluetooth to a light emitting module 101. However, the present disclosure is not limited hereto.

Finally, the hub 50 includes a power supply unit 60. The hub 50 is respectively coupled to at least one lamp, a receiver 103 and a power supply unit 60.

Finally, the main object of the receiver 103 is to receive the first-light-source control signal. When the receiver 103 receives a first-light-source control signal and transmits it to the light emitting module 101, differently colored light sources can be continuously created by controlling the blue light emitting diode chip 1011, the red light emitting diode chip 1012, the green light emitting diode chip 1013, and the synchronous or asynchronous light emission of the light adjustment elements. Additionally, the receiver 103 can be an infrared, radio or Bluetooth wireless receiver. For example in the present embodiment, the receiver 103 is an infrared receiver. However, the present disclosure is not limited hereto.

Finally, the lamp of the present disclosure can further include a reflecting unit 30 same as the description in the first embodiment, therefore the reflecting unit 30 is not further described.

### Fourth Embodiment

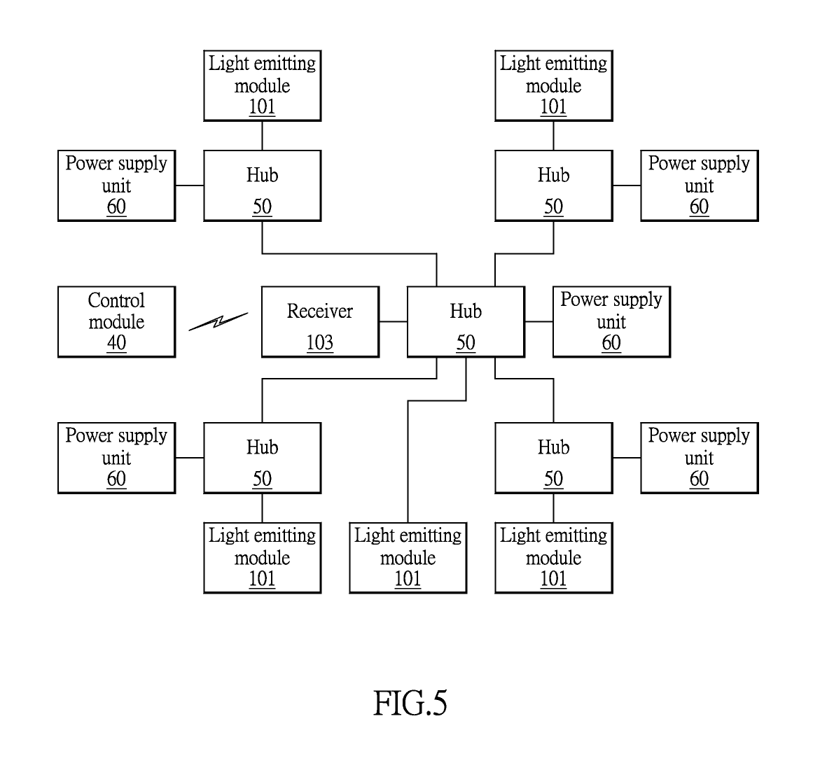

Referring to FIG. 5, the fourth embodiment of the present disclosure provides a light emitting diode lamp system, including: multiple lamps, a control module 40, multiple hubs 50 and a receiver 103. A light emitting diode lamp system is formed by serial connection between a hub 50 and multiple hubs 50.

Its difference with the third embodiment lies in a light emitting diode lamp system, in which the user can serially connect the hub 50 with multiple hubs 50, thereby forming a light emitting diode lamp system, for broadening the range of application of the light emitting diode lamp system. The lamp, control module and receiver of the fourth embodiment of the present disclosure are similar to those described in the third embodiment, and therefore are not further described.

Finally, the lamp of the present disclosure can further include a reflecting unit 30 same as the description in the first embodiment, therefore the reflecting unit 30 is not further described.

### Fifth Embodiment

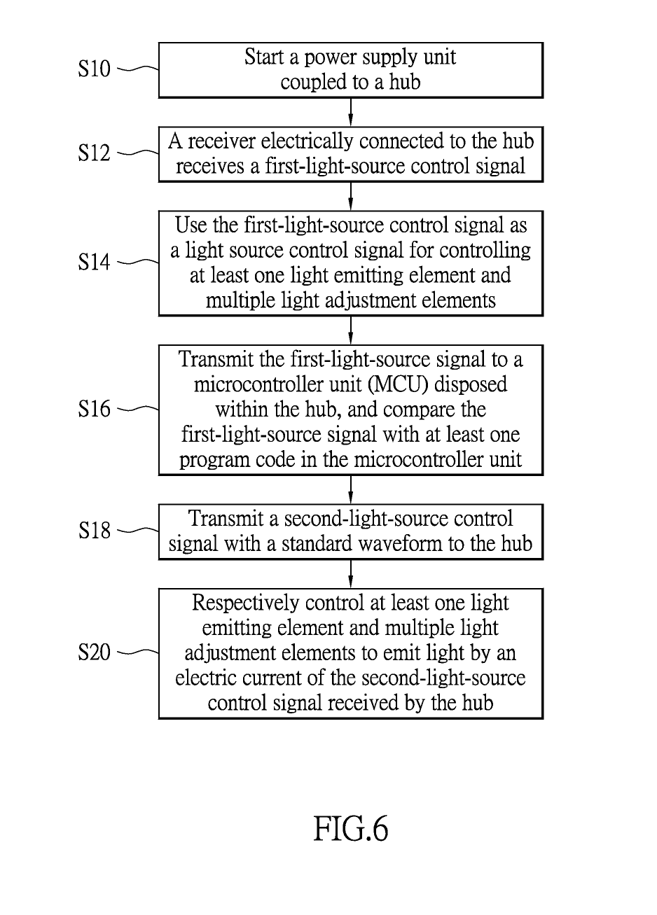

Referring to FIG. 6, the fifth embodiment of the present disclosure provides a control method for a light emitting diode lamp system, including the following steps:

In step S10, first start a power supply unit 60 coupled to a hub 50. In step S12, a receiver 103 electrically connected to the hub 50 receives a first-light-source control signal. In step S14, use the first-light-source control signal as a light source control signal for controlling at least one light emitting element 1020 and multiple light adjustment elements. In step S16, transmit the first-light-source signal to a microcontroller unit (MCU) disposed within the hub 50, and compare the first-light-source signal with at least one program code in the microcontroller unit. In step S18, transmit a second-light-source control signal with a standard waveform to the hub 50. In step S20, respectively control at least one light emitting element 1020 and multiple light adjustment elements to emit light by the electric current of the second-light-source control signal received by the hub 50.

The main object of disposing a microcontroller unit within the hub 50 is to address the potential problem that, when the first-light-source control signal sent by the control module 40, a long transmission distance or wide transmission angle leads to an altered or unrecognizable waveform of the first-light-source control signal after the first-light-source control signal received by the receiver 103 is decoded. More specifically, if the first-light-source control signal whose waveform is altered or unrecognizable is directly transmitted to multiple ports coupled to the hub 50, the first-light-source control signal further attenuates due to signal distribution, resulting in abnormal operation of at least one light emitting element 1020 and multiple light adjustment elements.

Therefore, a microcontroller unit is disposed within the hub 50 for allowing the present disclosure to screen and filter waveforms, comparing every first-light-source signal with at least one program code in the microcontroller unit. When the waveform of the first-light-source control signal is partially altered or unrecognizable, the first-light-source control signal is not transmitted to the hub 50. When the waveform of the first-light-source control signal can be recognized, a second-light-source control signal with a standard waveform is sent to the multiple ports of the hub 50. The first-light-source control signal and the second-light-source control signal are similar, and the second-light-source control signal is built in the microcontroller unit.

It must be emphasized that in the present embodiment, due to the signal intensity of the second-light-source control signal sent by the microcontroller unit, the present disclosure serially connects multiple lamps in a system without suffering signal attenuation.

### Advantages of the Embodiments

In summary of the above, the embodiments of the present disclosure provide a light emitting diode lamp and a system of the same. Through the unique design of the main body, the present disclosure can be applied on a traditional lamp, or applied with an MR16 lamp fixture. In other words, the main body can be used independently or in conjunction with an MR16 lamp fixture, thereby the present disclosure can broaden the range of application of the light emitting diode lamp and the system of the same.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A light emitting diode lamp, comprising:
a main body, having a light emitting module disposed therein, wherein the light emitting module comprises a first circuit board, at least one light emitting element and a dynamic light adjustment module, the multiple light emitting elements and the dynamic light adjustment module are disposed on the first circuit board, the dynamic light adjustment module has multiple light adjustment elements respectively corresponding to the light emitting elements; and
a heat sink, having a heat sink base and multiple heat sink fins, wherein one side of the heat sink base and the main body are connected, and the other side of the heat sink base is connected to the multiple heat sink fins.

2. The lamp according to claim 1, further comprising a reflecting unit disposed at the bottom of the main body, wherein the reflecting unit is connected to the main body.

3. The lamp according to claim 1, wherein the reflecting unit is of an MR16 type.

4. The lamp according to claim 1, wherein the light adjustment element comprises at least one blue light emitting diode chip, at least one red light emitting diode chip, and at least one green light emitting diode chip.

5. The lamp according to claim 1, wherein the light emitting element is at least one white light emitting diode chip.

6. A light emitting diode lamp system, comprising:
multiple lamps, including:
a main body, having a light emitting module disposed therein, wherein the light emitting module comprises a first circuit board, at least one light emitting element and a dynamic light adjustment module, the multiple light emitting elements and the dynamic light adjustment module are disposed on the first circuit board, the dynamic light adjustment module has multiple light adjustment elements respectively corresponding to the light emitting elements; and
a heat sink, having a heat sink base and multiple heat sink fins, wherein one side of the heat sink base and the main body are mutually connected, and the other side of the heat sink base is connected to the multiple heat sink fins;
a control module, including a second circuit board and multiple input units, wherein the multiple input units include at least a dynamic light adjustment start key and a dynamic light adjustment stop key;
at least one hub, each of which is respectively coupled with multiple lamps and power supply units; and
a receiver, coupled with multiple hubs, wherein the receiver receives the first-light-source control signal.

7. The lamp system according to claim 6, wherein the lamp further comprises a reflecting unit disposed at the bottom of the main body, and the reflecting units are connected to the main body.

8. The lamp system according claim 7, wherein the reflecting unit is of an MR16 type.

9. The lamp system according to claim 7, wherein the light adjustment element comprises at least one blue light emitting diode chip, at least one red light emitting diode chip, and at least one green light emitting diode chip.

10. The lamp system according to claim 7, wherein the light emitting element is at least one white light emitting diode chip.

11. The lamp system according to claim 7, wherein the hub has multiple ports.

12. A control method for a light emitting diode lamp system, comprising:
starting a power supply unit, wherein the power supply unit and a hub are coupled to each other;
a receiver which receives a first-light-source control signal, wherein a receiver and a hub are electrically connected;
using the first-light-source control signal as light source control signal for controlling at least one light emitting element and multiple light adjustment elements;
transmitting the first-light-source signal to a microcontroller unit disposed within the hub, wherein the first-light-source signal is compared with at least one program code in the microcontroller unit;
transmitting a second-light-source control signal of standard waveform to the hub; and
respectively controlling at least one light emitting element and multiple light adjustment elements by electric currents of the second-light-source control signal received by the hub.

13. The control method according to claim 12, wherein the first-light-source control signal and the second-light-source control signal are similar.
